(19) United States
(12) Patent Application Publication
(10) Pub. No.: US 2013/0300711 A1
(43) Pub. Date: Nov. 14, 2013

(54) TOUCH PANEL

(71) Applicant: PANASONIC CORPORATION, Osaka (JP)

(72) Inventors: Koji TANABE, Osaka (JP); Tetsutaro NASU, Nara (JP); Keishiro MURATA, Kyoto (JP)

(73) Assignee: PANASONIC CORPORATION, Osaka (JP)

(21) Appl. No.: 13/870,499

(22) Filed: Apr. 25, 2013

(30) Foreign Application Priority Data
May 10, 2012 (JP) 2012-108261

(51) Int. Cl. G06F 3/044

(52) U.S. Cl. CPC G06F 3/044
USPC 345/174

(57) ABSTRACT

A touch panel includes optically transparent upper conductive layers arranged in a predetermined direction and optically transparent lower conductive layers facing the upper conductive layers with a predetermined gap. One conductive layer of each of the upper conductive layers and each of the lower conductive layers has substantially a strip shape elongating in a longitudinal direction. The one conductive layer includes an optically transparent resin and metal filaments which are dispersed in the resin and which elongate in the longitudinal direction. In this touch panel, the conductive layer has a stable resistance, hence detecting a position accurately.

### TECHNICAL FIELD

The present invention relates to a touch panel to be used mainly for operating various electronic apparatuses.

### BACKGROUND

In recent years, sophistication and diversification are progressing in various electronic apparatus such as a mobile phone and an electronic camera. In this trend, an apparatus installed with an optically transparent touch panel on a front surface of a display device, such as a liquid crystal display device, is increasing in number. A user can switch multiple functions with his finger by touch-operating the panel while seeing the display of the rear side of the display device through the touch panel. In this circumstance, a touch panel which is easy to see the display which is put on the rear side of the display device through the touch panel and is also securely operable is demanded.

FIGS. 4 and 5 are a cross-sectional view and an exploded perspective view of conventional touch panel 500, respectively. Upper substrate 1 has a film shape and optically transparent. Upper conductive layers 2 which are optically transparent and have substantially strip shapes are arranged on an upper surface of upper substrate 1 in a front and back direction. Upper conductive layer 2 includes optically transparent resin 2A and silver filaments 2B dispersed in resin 2A.

Upper electrodes 3 are made of conductive material, such as silver, carbon, or copper foil. Each of one ends of upper electrodes 3 is connected to respective one ends of upper conductive layers 2, while the other ends of upper electrodes 3 extend to a right side periphery of upper substrate 1. Upper electrodes 3 extend in a left and right direction orthogonal to upper conductive layer 2.

Lower substrate 4 has a film shape and optically transparent, similarly to upper substrate 1. Lower conductive layers 5 which are optically transparent and have substantially strip shapes are arranged on an upper surface of lower substrate 4 in the left and right direction orthogonal to upper conductive layer 2. Lower conductive layer 5 includes optically transparent resin 5A and silver filaments 5B dispersed in resin 5A, similarly to upper conductive layer 2.

Lower electrodes 6 are made of conductive material, such as silver or carbon, similarly to upper electrode 3. Each of one ends of lower electrodes 6 is connected to respective one of ends of lower conductive layers 5, while the other ends of lower electrodes 6 extend to a right side periphery of lower substrate 4. Lower electrodes 6 extend in the left and right direction parallel to lower conductive layer 5.

Cover substrate 7 has a film shape and optically transparent. Upper substrate 1 is put on an upper surface of lower substrate 4 and adhered to lower substrate 4 with lower bonding layer 9. Cover substrate 7 is put on an upper surface of upper substrate 1 and is adhered to upper substrate 1 with upper bonding layer 8, thus providing touch panel 500.

Touch panel 500 is placed on a front of a display device, such as a liquid crystal display device, to be installed to an electronic apparatus. Upper electrodes 3 and lower electrodes 6 extend to the right side periphery are electrically connected to an electronic circuit of the electronic apparatus with a flexible wiring board and/or a connector.

In above configuration, when a voltage is applied from the electronic circuit alternately to upper electrodes 3 and lower electrodes 6, a user touches an upper surface of cover substrate 7 with his/her finger to operate a display of the display-device placed on a back side of touch panel 500. This operation changes a capacitance between upper conductive layer 2 and lower conductive layer 5 at a position touched with the finger. The electronic circuit detects the touched position based on the change in the capacitance, and switches multiple functions of the electronic apparatus.

For instance, when the user touches his/her desired menu on the upper surface of cover substrate 7 while menus are displayed on the back side display device, electric charge partially transmits to the finger to change the capacitance between upper conductive layer 2 and lower conductive layer 5 at the touched position. The electronic circuit detects the change in the capacitance, and then, identifies and selects the desired menu.

A conventional touch panel similar to touch panel 500 is disclosed in, e.g. Japanese Patent Laid-Open Publication No. 2009-170194.

### SUMMARY

A touch panel includes optically transparent upper conductive layers arranged in a predetermined direction and optically transparent lower conductive layers facing the upper conductive layers with a predetermined gap. One conductive layer of each of the upper conductive layers and each of the lower conductive layers has substantially a strip shape elongating in a longitudinal direction. The one conductive layer includes an optically transparent resin and metal filaments which are dispersed in the resin and which elongate in the longitudinal direction.

In this touch panel, the conductive layer has a stable resistance, hence detecting a position accurately.

### BRIEF DESCRIPTION OF DRAWINGS

FIG. 1 is a cross-sectional view of a touch panel according to an exemplary embodiment.

FIG. 2 is an exploded perspective view of the touch panel according to the embodiment.

FIGS. 3A to 3C are partial top plan views of the touch panel according to the embodiment for illustrating method of manufacturing the touch panel.

FIG. 4 is a cross-sectional view of a conventional touch panel.

FIG. 5 is an exploded perspective view of a conventional touch panel.

### DETAIL DESCRIPTION OF PREFERRED EMBODIMENT

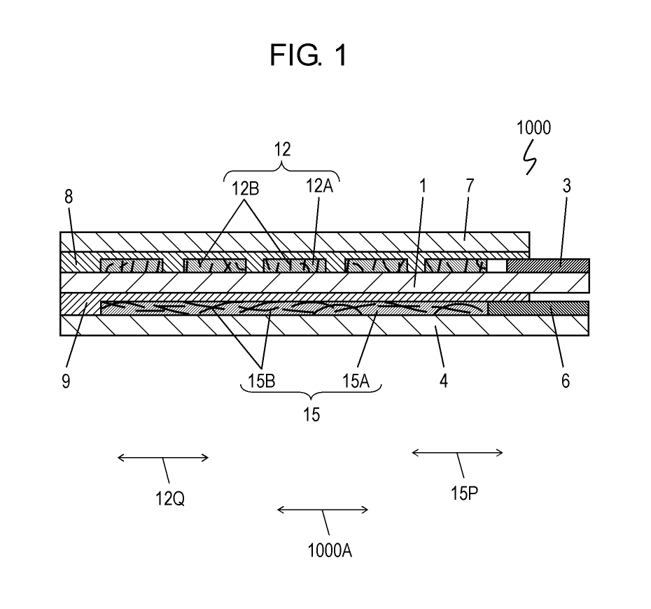

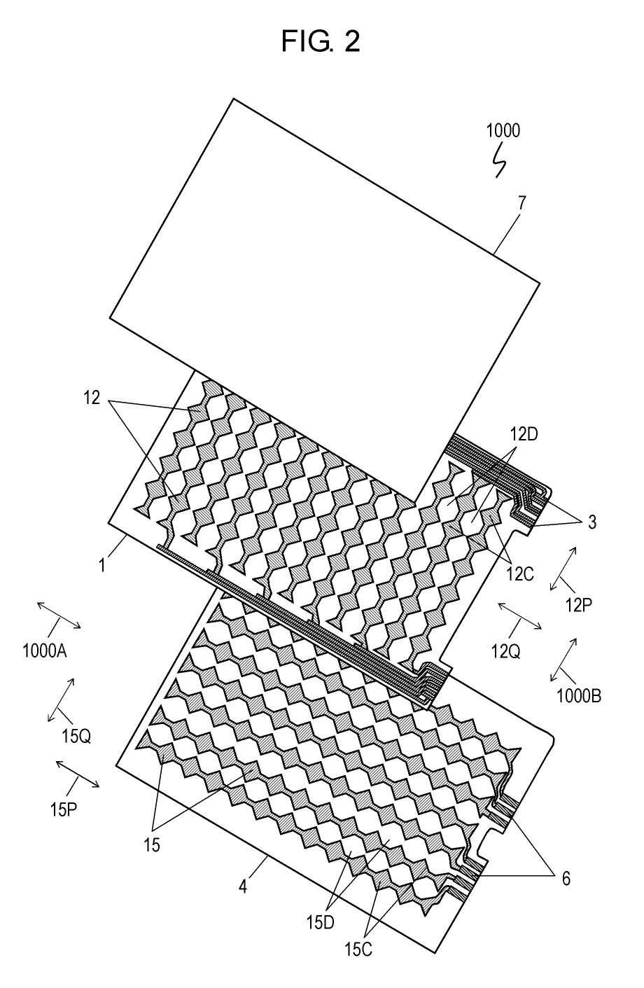

FIGS. 1 and 2 are a cross-sectional view and an exploded perspective view of touch panel 1000 according to an exemplary embodiment. Upper substrate 1 is made of optically transparent insulating material, such as polyethylene terephthalate, polyether sulphone, or polycarbonate, and has a film shape. Upper conductive layers 12 which are optically transparent and have substantially strip shapes are arranged in a predetermined direction 1000A on an upper surface of upper substrate 1.

Upper conductive layer 12 includes optically transparent resin 12A and metal filaments 12B dispersed in resin 12A. Upper conductive layer 12 namely resin 12A elongates in longitudinal direction 12P. Most of metal filaments 12B elongate in longitudinal direction 12P of upper conductive layer 12. Each metal filament 15B has an elongate axis along which metal filament elongates. Most of elongate axes of metal filaments 12B are directed in longitudinal direction 12P. Resin 12A has a thickness ranging from about 0.1 to 20 μm and is made of optically transparent insulating resin, such as acrylic. Metal filaments 12B have diameters ranging from about 10 to 300 nm and lengths ranging from about 1 to 100 μm, and are made of metal, such as silver. The diameters of metal filaments 12B may range preferably from about 30 to 60 nm while the lengths thereof may range preferably from about 5 to 40 μm In touch panel 1000 according to the embodiment, longitudinal direction 12P is identical to predetermined direction 1000B perpendicular to predetermined direction 1000A.

Each of one ends of upper electrodes 3 is connected to respective one of ends of upper conductive layers 12, while the other ends of upper electrodes 3 extend to a right side periphery of upper substrate 1. Upper electrodes 3 extend in predetermined direction 1000A. Upper electrode 3 is made of printed conductive material, such as silver or carbon, or made of metal foil, such as copper foil, that is made by a vapor deposition.

Lower substrate 4 has a film shape and optically transparent, similarly to upper substrate 1. Lower conductive layers 15 which are optically transparent and have substantially strip shapes are arranged in predetermined direction 1000B on an upper surface of lower substrate 4. Lower conductive layer 15 includes optically transparent resin 15A and metal filaments 15B dispersed in resin 15A, similarly to conductive layer 12 does. Resin 15A and metal filaments 15B of lower conductive layer 15 are made of identical materials to resin 12A and metal filaments 12B of upper conductive layer 12, respectively. Lower conductive layer 15 namely resin 15A elongates in longitudinal direction 15P. Most of metal filaments 15B elongate in longitudinal direction 15P of lower conductive layer 15. Each metal filament 15B has an elongate axis along which metal filament elongates. Most of elongate axes of metal filaments 15B are directed in longitudinal direction 15P. In touch panel 1000 according to the embodiment, longitudinal direction 15P is identical to predetermined direction 1000A.

Each of one ends of lower electrodes 6 is connected to respective one of ends of lower conductive layers 15, while the other ends of lower electrodes 6 extend to a right side periphery of lower substrate 4. Lower electrode 6 is made of conductive material, such as silver, carbon, or copper foil, similarly to upper electrode 3.

Upper conductive layer 12 includes rectangular portions 12C connected to each other. Opening portions 12D having substantially rectangular shapes are provided between rectangular portions 12C. Similarly, lower conductive layer 15 includes rectangular portions 15C connected to each other. Opening portions 15D having substantially rectangular shapes are provided between rectangular portions 15C. While upper substrate 1 is stacked on lower substrate 4, rectangular portions 12C of upper conductive layer 12 overlap opening portions 15D of lower conductive layer 15, and rectangular portions 15C of conductive layer 15 overlap opening portions 12D of upper conductive layer 12.

Cover substrate 7 is made of optically transparent insulating film, such as polyethylene terephthalate film. Upper substrate 1 is stuck onto an upper surface of lower substrate 4 with lower bonding layer 9 while cover substrate 7 is stuck onto an upper surface of upper substrate 1 with upper bonding layer 8, constituting touch panel 1000. Upper bonding layer 8 and lower bonding layer 9 are made of optically transparent bonding material, such as acrylic and rubber.

In touch panel 1000 according to the embodiment, upper conductive layers 12 arranged in predetermined direction 1000A face lower conductive layers 15 arranged in predetermined direction 1000B perpendicular to predetermined direction 1000A across upper substrate 1 with a predetermined gap between conductive layers 12 and 15.

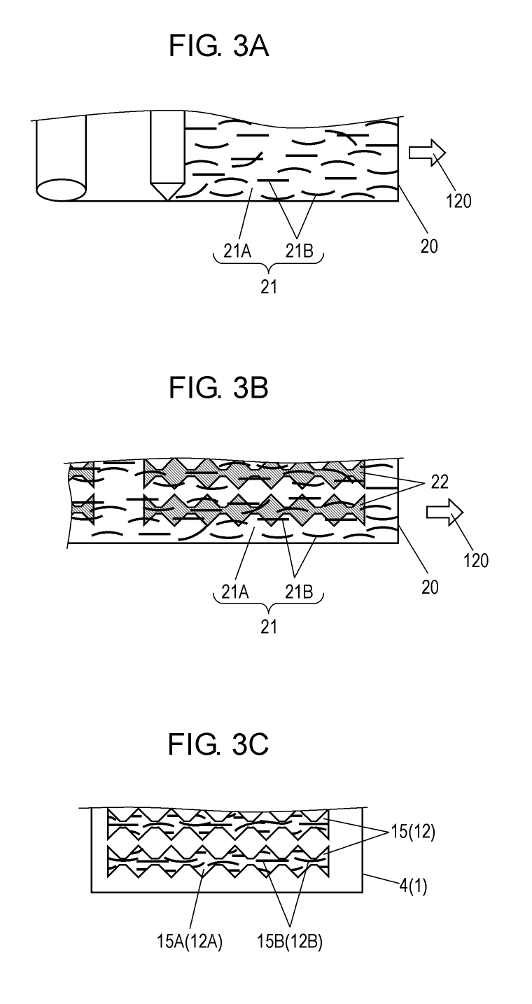

A method of forming upper conductive layer 12 and lower conductive layer 15 will be described below. FIGS. 3A to 3C are partial top plan views of touch panel 1000 for illustrating the method of manufacturing touch panel 1000.

As shown in FIG. 3A, while base material 20 having a strip shape and which becomes upper substrate 1 and lower substrate 4 is moved relatively in direction 120, optically transparent resin 21A having metal filaments 21B dispersed therein is applied or printed onto an upper surface of base material 20, thereby forming conductive thin film 21 entirely on the upper surface of base material 20. Since conductive thin film 21 is formed on the upper surface of base material 20 while base material 20 moves relatively in direction 120, most of metal filaments 21B in resin 21A are arranged so as to elongate in direction 120.

As shown in FIG. 3B, next, in order to making patterns of upper conductive layer 12 and lower conductive layer 15, conducting thin film 21 is masked with coating film 22 made of insulating resin, such as a dry film, and then, base material 20 is immersed in etching solution to dissolve and remove unnecessary portions of conductive film 21.

Then, coating film 22 is peeled off, and then, base material 20 is cut to have a predetermined shape of upper substrate 1 and lower substrate 4, thereby providing, as shown in FIG. 3C, lower substrate 4 having lower conductive layers 15 thereon in which most of metal filaments 15B elongate in direction 120 in resin 15A, and providing upper substrate 1 having upper conductive layers 12 thereon in which most of metal filaments 12B elongate in direction 120 in resin 12A.

An operation of touch panel 1000 will be described below. Touch panel 1000 is placed in front of a display device, such as liquid crystal display to be installed to an electronic apparatus. Upper electrodes 3 and lower electrodes 6 which extend to the right side periphery are electrically connected with an electronic circuit of the electronic apparatus with a flexible wiring board and a connector.

While a voltage is applied from the electronic circuit alternately to upper electrodes 3 and lower electrodes 6, when a user touches an upper surface of cover substrate 7 with, e.g. his/her finger according to a display of the display device, a capacitance between upper conductive layer 12 and lower conductive layer 15 changes at the position where the finger touches. The electronic circuit detects the touched position, and switches multiple functions of the electronic apparatus.

For, instance, while menus are displayed on the display device, when the user touches a point of his/her desired menu on the upper surface of cover substrate 7, an electric charge is partially transmitted to the finger, and changes a capacitance between upper conductive layer 12 and lower conductive layer 15 at the touched position. The electronic circuit detects the change of the capacitance, and then, identifies and selects the desired menu.

In touch panel 1000 according to the embodiment, most of metal filaments 12B in upper conductive layers 12 elongate in longitudinal direction 12P in which upper conductive layer 12 elongates while most of metal filaments 15B in lower conductive layer 15 elongate in longitudinal direction 15P in which lower conductive layer 15 elongates. Therefore, upper conductive layer 12 and lower conductive layer 15 have a stable low resistance with less variation, accordingly, allowing touch panel 1000 to accurately detect the position the user touched.

In touch panel 1000 according to the embodiment, lower substrate 4 having lower conductive layers 15 on the upper surface thereof is stuck to an under surface of upper substrate 1 having upper conductive layers 12 on the upper surface thereof. The touch panel according to the embodiment may not necessarily include upper substrate 1 and lower substrate 4. In this case, upper conductive layers 12 may be provided on a lower surface of upper bonding layer 8, lower bonding layer 9 may be formed on a lower surface of upper conductive layer 12, and lower conductive layer 15 may be formed on a lower surface of lower bonding layer 9. In this case, upper conductive layers 12 face lower conductive layers 15 across lower bonding layer 9 with a predetermined gap, providing the same effects as touch panel 1000.

Touch panel 1000 according to the embodiment, most of metal filaments 12B and 15B of upper conductive layer 12 and lower conductive layer 15 elongate in longitudinal direction 12P and 15P. However, most of metal filaments 12B of upper conductive layers 12 elongate in longitudinal direction 12P while most of filaments 15B of lower conductive layer 15 may not necessarily elongate in longitudinal direction 15P. Alternatively, most of metal filaments 12B of upper conductive layers 12 may not necessarily elongate in longitudinal direction 12P while most of metal filaments 15B of lower conductive layer 15 elongate in longitudinal direction 15P.

Since metal filaments 12B and 15B have diameters ranging from 30 to 60 nm and have lengths ranging from 5 to 40 μm, metal filaments 12 B and 15B exhibit a conductivity only in their longitudinal direction, i.e., their axis direction, but do not exhibit a conductivity in directions perpendicular to the longitudinal direction. In the case that metal filament 12B (15B) out of metal filaments 12B (15B) is angled with respect to both of longitudinal direction 12P (15P) and direction 12Q (15Q), the conductivity in direction 12P (15P) and direction 12Q (15Q) matches components of a vector of eth axis direction of metal filament 12B (15B) in direction 12P (15P) and direction 12Q (15Q). Therefore, the ratio of axis directions of most of metal filaments 12B (15B) contained in conductive layer 12 (15) determines a conductivity of conductive layer 12 (15) in direction 12P (15P) and a conductivity of conductive layer 12 (15) in direction 12Q (15Q).

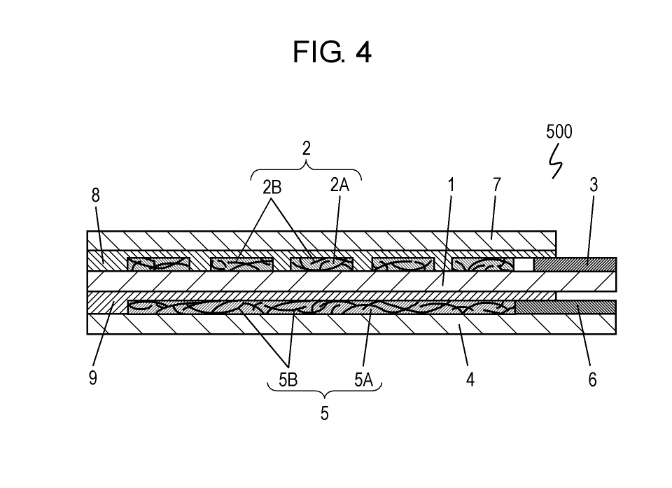

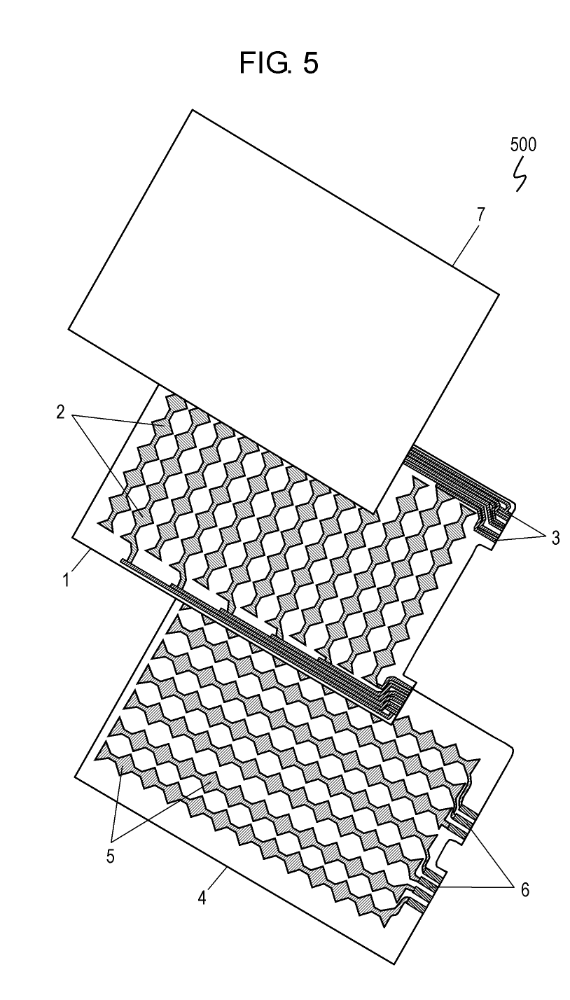

In conventional touch panel 500 shown in FIGS. 4 and 5, axes of silver filaments 2B and 5B dispersed in resin 2A and 5A of upper conductive layer 2 and lower conductive layer 5 are arranged in the longitudinal direction of upper conductive layer 2 and lower conductive layer 5 and also in a width direction perpendicular to the longitudinal direction. In conventional touch panel 500, the resistance value of conductive layer 2 (5) in the longitudinal direction is almost the same as the resistance of conductive layer 2 (5) in the direction perpendicular to the longitudinal direction. Accordingly, the resistance value of upper conductive layer 2 and lower conductive layer 5 becomes large and has a large variation.

In touch panel 1000 according to the embodiment, the resistivity of conductive layer 12 (15) in direction 12Q (15Q) perpendicular to longitudinal direction 12P (15P) is larger than the resistivity of conductive layer 12 (15) in longitudinal direction 12P (15P), and is, e.g., about 1.3 to 3 times the resistivity of conductive layer 12 (15) in longitudinal direction 12P (15P). Thus, most of metal filaments 12B (15B) are controlled to elongate in longitudinal direction 12P (15P) with the planar evenness of the conductivity of conductive layer 12 (15) kept constant. This provides conductive layer 12 (15) with a low, stable resistance value in longitudinal direction 12P (15P), thus providing preferable characteristics of the touch panel. According to the embodiment, the ratio of metal filaments 12B (15B) elongating in longitudinal direction 15 to all of metal filaments 12B (15B) in conductive layer 12 (15) ranges from 57% to 79%.

As described above, in touch panel 1000 according to the embodiment, one of each of upper conductive layers 12 and each of lower conductive layers 15 includes optically transparent resin 12A (15A) and metal filaments 12B (15B) which are dispersed in resin 12A (15A) and which elongate in longitudinal direction 12P(15P). Consequently, one of each of upper conductive layers 12 and each of lower conductive layers 15 has a low and stable resistance value, hence allowing touch panel 1000 to detect the position accurately. Further, another of each of upper conductive layers 12 and each of lower conductive layers 15 also includes optically transparent resin 12A (15A) and metal filaments 12B (15B) which are dispersed in resin 12A (15A) and which elongate in longitudinal direction 12P(15P). Consequently, both of upper conductive layer 12 and lower conductive layer 15 have a low and stable resistance value, hence allowing touch panel 1000 to detect the position accurately.

In the embodiment, terms, such as “upper conductive layer”, “lower conductive layer”, and “upper surface”, indicating directions indicate relative directions depending on only a relative positional relationship of components, such as the upper conductive layer and the lower conductive layer, of the touch panel, and do not indicate absolute directions, such as a vertical direction.

What is claimed is:

1. A touch panel comprising:
a plurality of optically transparent upper conductive layers arranged in a predetermined direction; and
a plurality of optically transparent lower conductive layers facing the plurality of upper conductive layers with a predetermined gap,
wherein one of each of the plurality of upper conductive layers and each of the plurality of lower conductive layers has substantially a strip shape elongating in a first longitudinal direction, and
wherein said one of each of the plurality of upper conductive layers and each of the plurality of lower conductive layers includes:
an optically transparent first resin; and
a plurality of first metal filaments which are dispersed in the first resin and which elongate in the first longitudinal direction.

2. The touch panel according to claim 1, wherein a first resistivity of said one of each of the plurality of upper conductive layers and each of the plurality of lower conductive layers in a direction perpendicular to the first longitudinal direction is larger than a second resistivity of said one of each of the plurality of upper conductive layers and each of the plurality of lower conductive layers in the first longitudinal direction.

3. The touch panel according to claim 1, wherein the first resistivity is 1.3 to 3 times of the second resistivity.

4. The touch panel according to claim 1,
wherein another one of each of the plurality of upper conductive layers and each of the plurality of lower conductive layers has substantially a strip shape elongating in a second longitudinal direction, and
wherein said another one of each of the plurality of upper conductive layers and each of the plurality of lower conductive layers includes:
an optically transparent second resin; and
a plurality of second metal filaments which are dispersed in the second resin and which elongate in the second longitudinal direction.

5. The touch panel according to claim 4, wherein a first resistivity of said another one of each of the plurality of upper conductive layers and each of the plurality of lower conductive layers in a direction perpendicular to the first longitudinal direction is larger than a second resistivity of said another one of each of the plurality of upper conductive layers and each of the plurality of lower conductive layers in the first longitudinal direction.

6. The touch panel according to claim 5, wherein the first resistivity is 1.3 to 3 times of the second resistivity.

7. A touch panel comprising:
a plurality of optically transparent upper conductive layers arranged in a predetermined direction; and
a plurality of optically transparent lower conductive layers facing the plurality of upper conductive layers with a predetermined gap,
wherein one of each of the plurality of upper conductive layers and each of the plurality of lower conductive layers has substantially a strip shape elongating in a first longitudinal direction, and
wherein a first resistivity of said one of each of the plurality of upper conductive layers and each of the plurality of lower conductive layers in a direction perpendicular to the first longitudinal direction is larger than a second resistivity of said one of each of the plurality of upper conductive layers and each of the plurality of lower conductive layers in the first longitudinal direction.

8. The touch panel according to claim 7, wherein the first resistivity is 1.3 to 3 times of the second resistivity.

9. The touch panel according to claim 7,
wherein another one of each of the plurality of upper conductive layers and each of the plurality of lower conductive layers has substantially a strip shape elongating in a second longitudinal direction, and
wherein a third resistivity of said another one of each of the plurality of upper conductive layers and each of the plurality of lower conductive layers in a direction perpendicular to the second longitudinal direction is larger than a fourth resistivity of said another one of each of the plurality of upper conductive layers and each of the plurality of lower conductive layers in the second longitudinal direction.

10. The touch panel according to claim 9, wherein the third resistivity is 1.3 to 3 times of the fourth resistivity.
